(19) United States
(12) Patent Application Publication
(10) Pub. No.: US 2026/0210417 A1
(43) Pub. Date: Jul. 23, 2026

(54) BRAKE PAD ASSEMBLY

(71) Applicant: ArvinMeritor Technology, LLC, Troy, MI (US)

(72) Inventors: Ricky J. Mains, JR., Troy, MI (US); Bheemesha Vaidya, Harapanahalli, Karnataka (IN); Prathap N. Krishnan, Bangalore, Karnataka (IN); Joseph W. Ghering, Troy, MI (US); Suresh Sundaram, Cuddalore, Tamil Nadu (IN); Justin J. McCoy, Troy, MI (US)

(21) Appl. No.: 19/033,916

(22) Filed: Jan. 22, 2025

(51) Int. Cl. F16D 65/092; F16D 66/00

(52) U.S. Cl. CPC F16D 65/092; F16D 66/00

(57) ABSTRACT

A brake pad assembly for a heavy-duty vehicle disc brake. The brake pad assembly includes a backplate and friction material supported on the backplate. The backplate includes a first face for supporting the friction material, a second face, opposing the first face, and a slot for receiving a sensor arrangement, the slot extending through the backplate from the first face to the second face. The slot has a varying cross-sectional area through the backplate.

### FIELD OF THE DISCLOSURE

The present disclosure relates to a brake pad assembly.

### BACKGROUND

Modern automotive brake pad assemblies must perform multiple tasks with high precision, including effective braking, heat dissipation, noise reduction, and durability. As technology advances, these assemblies are becoming increasingly complex. For example, sensors are increasingly integrated within the brake pad assemblies to monitor wear, temperature, and pressure.

### SUMMARY OF THE DISCLOSURE

A first aspect of the invention provides a brake pad assembly for a heavy-duty vehicle disc brake, the brake pad assembly comprising a backplate, and friction material supported on the backplate. The backplate comprises a first face, for supporting the friction material, a second face, opposing the first face, and a slot for receiving a sensor arrangement, the slot extending through the backplate from the first face to the second face. The slot having a varying cross-sectional area through the backplate.

The varying cross-sectional area allows the backplate to support a sensor without any additional supports or restraints.

Optionally, an open end of the slot is at a radially outer edge of the backplate.

The backplate can be easily manufactured (from an edge of the backplate) and the sensor can be easily mounted onto the backplate.

Optionally, the slot is arranged substantially midway along a radially outer edge of the backplate.

The sensor can be positioned in the backplate to effectively monitor wear or other characteristics of the brake pad assembly without being exposed to excessive heat generated at other parts of the backplate (e.g. the center region). The sensor can also be easily mounted to the backplate in this arrangement.

Optionally, the slot comprises a first region proximal to the first face, the first region having a first cross-sectional area, a second region proximal to the second face, the second region having a second cross-sectional area, wherein the second cross-sectional area is greater than the first cross-sectional area.

The reduction in cross-sectional area towards the first side means that a sensor such as a pad wear warning indicator can be received and securely positioned within the slot.

Optionally, the cross-sectional area of the slot changes from the first region to the second region in a stepped arrangement.

Stepped arrangements are easier to manufacture and could provide more accurate location of the sensor.

Optionally, the backplate defines an axial direction extending from the first face to the second face, and the first region has a depth in the axial direction that is greater than a depth of the second region in the axial direction.

The change in depth can follow the shape of different sensors, so the backplate can receive different types of sensors.

Optionally, the backplate defines an axial direction extending from the first face to the second face, and the change in cross-sectional area from the first region to the second region allows a sensor to be located in the slot to limit movement of the sensor in the axial direction.

The backplate can securely position and secure the sensor in the slot without any additional fixtures. This makes the brake pad assembly easier to manufacture.

Optionally, the second region is at least partially formed by a recess in the second face of the backplate.

Such an arrangement is relatively easy to manufacture.

Optionally, the slot further comprises a third region between the first region and the second region, the third region having a third cross-sectional area, wherein the second cross-sectional area of the second region is greater than the third cross-sectional area of the third region.

The three regions allow the backplate to accommodate different types of sensor.

Optionally, the first cross-sectional area is less than the third cross-sectional area.

Such an arrangement is suitable for accommodating a range of sensors.

Optionally, the cross-sectional area of the slot changes from the second region to the third region in a stepped arrangement.

Optionally, the cross-sectional area of the slot changes from the third region to the first region in a stepped arrangement.

Stepped arrangements are easier to manufacture and could provide more accurate location of the sensor.

Optionally, the backplate has an axial direction extending from the first face to the second face, and the depth of the first region in the axial direction is greater than a depth of the third region in the axial direction.

The change in depth follows the shape of different sensors, so the backplate is suitable for receiving different types of sensors.

Optionally, wherein the depth of the third region in the axial direction is greater than the depth of the second region in the axial direction.

The change in depth follows the shape of the different sensors, so the backplate can receive different types of sensors.

Optionally, the third region is at least partially formed by a second recess formed in the first recess, wherein the second recess extends from the first face to the second face.

Such an arrangement is relatively easy to manufacture.

Optionally, the backplate comprises a vertical direction extending from a radially outer edge to a radially inner edge of the backplate, wherein the slot has a symmetrical cross-section along the vertical direction of the slot.

Such an arrangement is relatively easy to manufacture.

Optionally, each region has substantially the same shape.

Such an arrangement is relatively easy to manufacture.

Optionally, each region is generally U-shaped.

Such an arrangement is relatively easy to manufacture, and reduces stress concentration in the backplate.

Optionally, the slot comprises a recess that extends from a radially outer edge of the backplate, the recess having a base that is substantially perpendicular to an axial direction through the backplate.

The recess advantageously forms a shelf that can be used to support a sensor received on the backplate.

Optionally, the slot further comprises a neck connecting the recess to a central portion of the slot, wherein the neck is configured to secure a sensor within the slot.

As the neck is narrower than the adjacent areas, it can be used to secure the sensor in place (e.g. in a snap fit configuration) in the slot.

Optionally, the backplate has a radially outer edge, a first side adjacent the radially outer edge and second side adjacent the radially outer edge and opposing the first side, wherein the backplate further comprises at least one horn extending from the radially outer edge at the or each side.

Optionally, the friction material comprises a slot extending through the friction material.

Optionally, the slot in the friction material is aligned with the slot in the backplate.

Optionally, the friction material has a first face supported on the backplate, a second face, opposing the first face, and the slot has a varying cross-sectional area through the friction material.

Optionally, the friction material slot is substantially U-shaped.

Optionally, the backplate has a height of 100 mm to 115 mm, and a width of 205 mm to 215 mm.

Such a backplate size provides a brake pad assembly suitable for a range of brakes.

Optionally, the contact area ratio between the first side and the friction material is greater than 1.1.

Such a relatively high contact area ratio advantageously leads to greater heat dissipation capability.

A second aspect of the invention provides a brake pad assembly for a heavy-duty vehicle disc brake. The brake pad assembly comprising a backplate and friction material supported on the backplate. The backplate including a first face, for supporting the friction material, a second face, opposing the first face. A contact area ratio between the first side and the friction material is greater than 1.1.

Such a relatively high contact area ratio advantageously leads to greater heat dissipation capability.

Optionally, the contact area ratio is between 1.1 and 1.3.

Such a relatively high contact area ratio advantageously leads to greater heat dissipation capability.

Optionally, the backplate is generally trapezoidal and has a height of 100 mm to 115 mm, and a width of 205 mm to 215 mm, wherein the friction material has substantially the same shape as the backplate.

A further aspect of the disclosure provides a brake pad assembly for a heavy-duty vehicle disc brake, the brake pad assembly comprising: a backplate, and friction material supported on the backplate. The backplate includes a first face, a second face, at least two horns, and a pad spring. The first face configured for supporting the friction material, the second face opposing the first face, and the at least two horns extending from a radially outer edge of the backplate. The pad spring received on a radially outer edge of the backplate and including a central portion and first and second end portions. The central portion provided with a protrusion extending in a radially outward direction away from the backplate. The first and second end portions configured for co-operation with respective horns on the backplate, and the connector portions between the central portion and respective end portions. The protrusion has a height in the range of 2 mm to 10 mm relative to the connector portions, and the end portions of the pad spring are curved inwardly towards the backplate.

The height of the central portion allows the accommodation of a sensor once installed in place. The end portions can engage with the horns on the back of the backplate to retain the spring.

Optionally, the end portions curve inwardly through in a range 120 degrees to 180 degrees.

The end portions are therefore shaped to easily engage with the horns on the backplate.

Optionally, the height of the central portion is in the range of 4 mm to 8 mm.

The central portion therefore has enough clearance between the backplate and the central portion to accommodate a sensor on the backplate.

Optionally, the pad spring further comprises concave portions between each connector portion and the central portion, the concave portions having a radius of substantially 1.5 mm.

By having curved portions between each connector portion and the central portion, the spring can easily deform under load. This minimizes the likelihood of the spring breaking during use.

Optionally, each connector portion has at least one region with a bend radius with respect to a central axis of the spring.

By having a curved region on each connector portion, the spring can easily deform under load. This minimizes the likelihood of the spring breaking during use.

Optionally, wherein the at least one region is substantially midway between the central portion and the respective end portion.

The spring can therefore distribute the load equally along the connector portion. This minimizes the likelihood of the spring breaking during use.

A brake pad assembly for a heavy-duty vehicle disc brake, the brake pad assembly comprising a backplate and friction material supported on the backplate. The backplate includes a first face, for supporting the friction material, a second face, opposing the first face, and at least two horns extending from a radially outer edge of the backplate. The brake pad assembly further including a pad spring received on a radially outer edge of the backplate and including a central portion, connector portions, and first and second end portions for co-operation with respective horns on the backplate. The central portion including a protrusion extending in a radially outward direction away from the backplate and the connector portions between the central portion and respective end portions. The connector portions are substantially arcuate and the protrusion has a height in the range of 2 mm to 10 mm relative to the connector portions. The end portions of the pad spring curve outwardly away from the backplate.

The height of the central portion allows the accommodation of a sensor once installed in place. The end portions can move along the radially outer surface of the backplate as the spring compresses.

Optionally, each connector portion has a constant bend radius.

Optionally, the bend radius of each connector portion is in a range of 5 mm to 15 mm.

Optionally, a height of the pad spring from the central portion to the end portions is in a range of 10 mm to 30 mm.

A further aspect of the present disclosure provides a brake pad assembly for a heavy-duty vehicle disc brake. The brake pad assembly including a backplate and friction material supported on the backplate. The backplate including a first face, a second face, and at least two horns extending from a radially outer edge of the backplate. The first face configured for supporting the friction material and the second face opposing the first face. The brake pad assembly further including a pad spring received on a radially outer edge of the backplate and including a central portion, first and second end portions, and connector portions. The first and second end portions configured for co-operation with respective horns on the backplate and the connector portions disposed between the central portion and respective end portions. The central portion is substantially planar with respect to a central axis of the pad spring and the end portions curve outwardly away from the backplate. Each connector portion including a first connector region and a second connector region, the second connector region is inclined with respect to the first connector region with respect to the central axis.

The height of the central portion allows the accommodation of a sensor once installed in place. The end portions can move along the radially outer surface of the backplate as the spring compresses.

Optionally, the first and second connector regions are substantially planar.

Optionally, the spring has a height between the central portion and the end portions, wherein the height of the spring is in the range of 15 mm to 30 mm.

Optionally, the pad spring is formed as one continuous part.

Optionally, the pad spring is configured to be loaded at one point.

Advantageously, such a spring can be used in a range of brake pad assemblies.

Optionally, the pad spring is configured to be loaded at two points.

Advantageously, such a spring can be used in a range of brake pad assemblies.

A further aspect of the disclosure provides a pad spring for use in a brake pad assembly as set out above.

### BRIEF DESCRIPTION OF THE DRAWINGS

Further features and advantages of examples embodying the present disclosure will be further described below, by way of example only, with reference to the accompanying drawings in which:

FIG. 1 is a perspective view of a disc brake assembly;

FIG. 2 is a top-down view of a disc brake assembly;

FIG. 3 shows a perspective view of a brake pad assembly;

FIG. 4A shows a front view of the backplate;

FIG. 4B shows a top-down view of the backplate;

FIG. 5 shows a perspective view of a brake pad assembly;

FIGS. 6A-6C show exemplary pad springs.

### DETAILED DESCRIPTION

As required, detailed embodiments of the present invention are disclosed, herein; however, it is to be understood that the disclosed, embodiments are merely exemplary of the invention, that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

As stated above, automotive brake pad assemblies must perform multiple functions such as effective braking, heat dissipation, noise reduction and durability. To perform these functions, sensors may be integrated within brake pad assemblies to monitor wear, temperature, and pressure. However, securely implementing these sensors is challenging due to harsh operating conditions like high temperatures, friction, and mechanical stress. Ensuring sensor integrity without compromising braking performance is complex.

Furthermore, excessive heat generation within the brake pad assembly during use can lead to reduced performance and increased wear. Managing this heat is crucial to maintaining the efficiency and longevity of the brake pad assembly.

There is a need for an improved brake pad assembly.

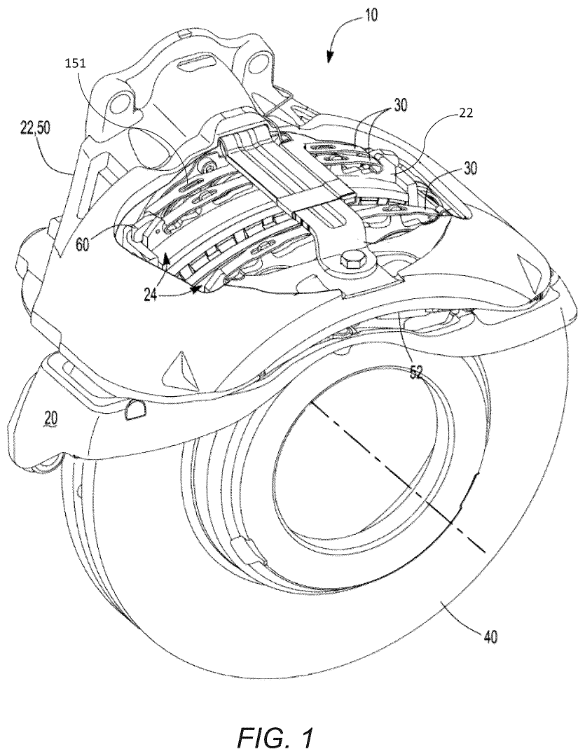

Referring to FIG. 1, an example of a disc brake assembly 10 is shown. The disc brake assembly 10 may be provided as part of a vehicle, such as a truck, bus, farm equipment, military transport or weaponry vehicle, or cargo loading equipment for land, air, or marine vessels. In at least one configuration, the disc brake assembly 10 may include a brake carrier 20, a brake caliper 22, at least one brake pad assembly 24, a retainer strap 26, and a sensor assembly 28 (shown in more detail in FIG. 5). One or more pad springs 30 may also be provided with the disc brake assembly 10.

The brake carrier 20 may facilitate mounting of the disc brake assembly 10. For instance, the brake carrier 20 may be fixedly mounted to a component of the vehicle, such as an axle assembly or a knuckle. The brake carrier 20 may receive and support the brake pad assemblies 24 and may include an opening through which a brake rotor 40 may extend. As such, the brake carrier 20 may straddle the brake rotor 40 and may help position brake pad assemblies 24 on opposite sides of the brake rotor 40.

The brake caliper 22 may be mounted to the brake carrier 20 and may support various components of the disc brake assembly 10. In addition, the brake caliper 22 may help position the brake pad assemblies 24 with respect to the brake rotor 40 to facilitate braking of the vehicle as will be discussed in more detail below. In at least one configuration, the brake caliper 22 may include a caliper housing 50 and a caliper bridge 52.

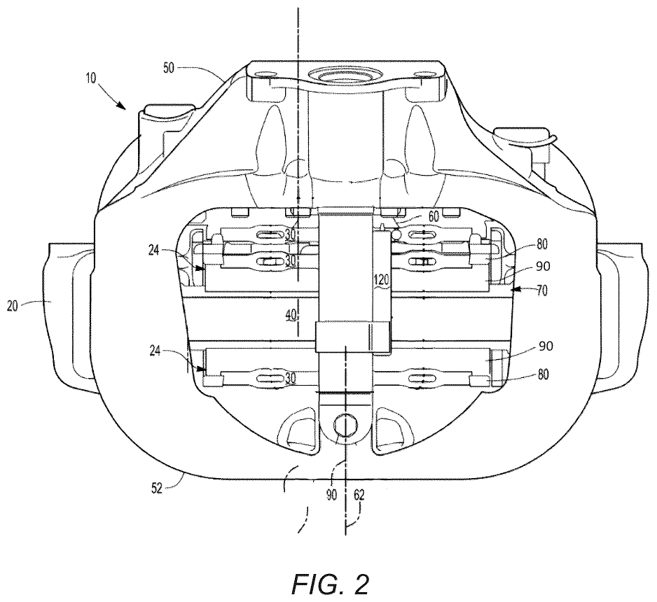

Referring to FIGS. 1 and 2, the caliper housing 50 may be moveably disposed on the brake carrier 20. For example, the caliper housing 50 may be slidable along a pair of guide pins that may be fixedly disposed on the brake carrier 20. The caliper housing 50 may receive or support various components that may facilitate actuation of a brake pad assembly 24. For instance, the caliper housing 50 may support a tappet 60 that may protrude from an internal chamber of the caliper housing 50.

Referring primarily to FIG. 2, the tappet 60 may extend from the caliper housing 50 toward the brake rotor 40 to engage a brake pad assembly 24. The tappet 60 may be moveable along an axis 62 with respect to the caliper housing 50 such that the tappet 60 may move toward and away from the brake rotor 40. For instance, an actuator may extend the tappet 60 to actuate a brake pad assembly 24 that is disposed between the caliper housing 50 and the brake rotor 40 into engagement with the brake rotor 40. A reaction force may then move the caliper housing 50 and caliper bridge 52 with respect to the brake carrier 20 to actuate a brake pad assembly 24 that is disposed between the caliper bridge 52 and the brake rotor 40 into engagement with an opposite side of the brake rotor 40 to help slow rotation of the brake rotor 40 and an associated vehicle wheel. Optionally, one or more biasing members, such as retraction springs may be provided to facilitate retraction of the brake pad assemblies 24 away from the brake rotor 40 when braking is not desired.

The caliper bridge 52 may be fixedly positioned with respect to the caliper housing 50. The caliper bridge 52 may be integrally formed with the caliper housing 50 or may be a separate component that is mounted to the caliper housing 50. For example, the caliper bridge 52 may be coupled or secured to the caliper housing 50 with one or more fasteners, such as bolts. In at least one configuration, the caliper bridge 52 may cooperate with the caliper housing 50 to define a cavity 70, which is best shown in FIG. 2.

The cavity 70 may at least partially receive the brake pad assemblies 24 and the brake rotor 40. The cavity 70 may be configured as a large through hole that may be encircled by the brake caliper 22. A portion of the brake carrier 20 may extend into the cavity 70 and may help position the brake pad assemblies 24. As shown in FIG. 2, the brake pad assemblies 24 may be disposed on opposite sides of the brake rotor 40 and may have similar or identical configurations. The brake pad assembly 24 includes a backplate 80 and friction material 90 (described in further detail below). The brake pad assemblies 24 may be configured to engage opposite sides of the rotor 40 to slow the rotation of a vehicle wheel. More specifically, the tappet 60 may engage the backplate 80 of the brake pad assembly 24 that is positioned between the brake rotor 40 and the caliper housing 50. For instance, the tappet 60 may engage a side of the backplate 80 that may face away from the brake rotor 40 and that may be disposed opposite the friction material 90. The backplate 80 of the other brake pad assembly 24 may engage the caliper bridge 52.

The brake pad assemblies 24 may be inserted into the cavity 70 and installed on the brake carrier 20 or removed from the cavity 70 and the brake carrier 20 when the retainer strap 26 is removed. The retainer strap 26 may therefore be removably mountable to the brake caliper 22. For instance, the retainer strap 26 may be removed from the brake caliper 22 to facilitate removal or replacement of a brake pad assembly 24 and may be installed on the brake caliper 22 to inhibit removal of a brake pad assembly 24. In this example, the retainer strap 26 extends across the brake pad assemblies 24 and the cavity 70 of the brake caliper 22 to help retain the brake pad assemblies 24 in the brake carrier 20 when the retainer strap 26 is secured to the brake caliper 22. The retainer strap 26 may engage or contact a brake pad assembly 24 or a pad spring 30 when the retainer strap 26 is installed and secured to the brake caliper 22.

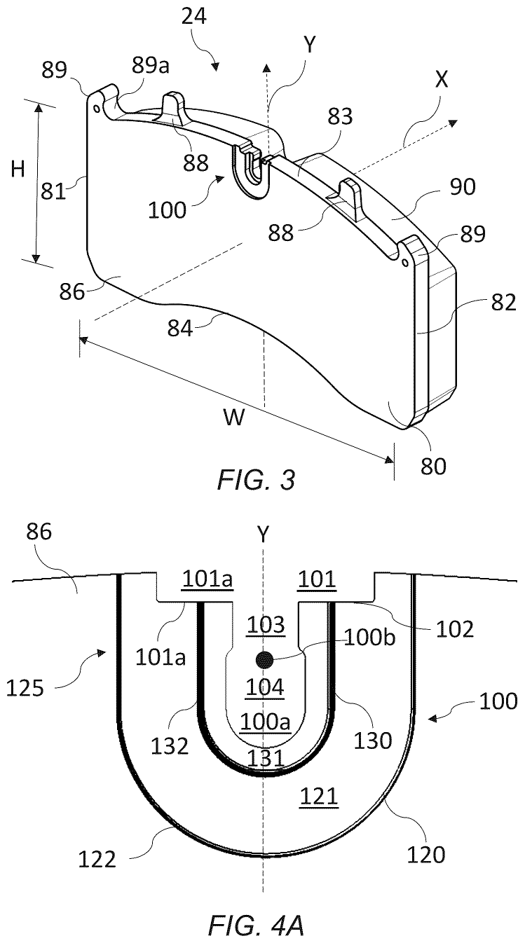

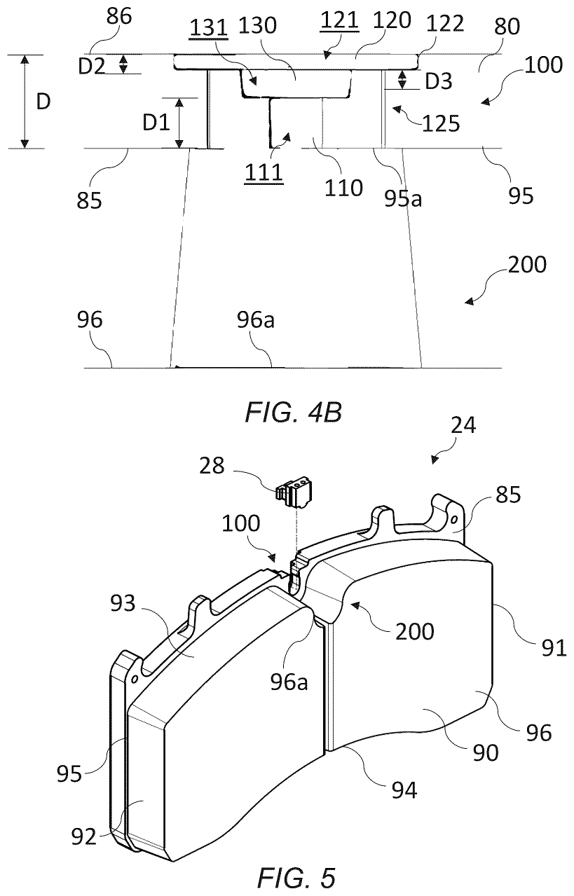

An exemplary brake pad assembly 24 is shown in more detail in FIG. 3. As shown, the backplate 80 may be configured as a generally flat plate and may be made of any suitable material, such as a metal alloy. The backplate 80 may be a structural member of the brake pad assembly 24. The backplate 80 has a first face 85 (see FIG. 4B) and an opposing second face 86. The backplate 80 has an axial direction X that extends from the first face 85 to the second face 86. As shown in more detail in FIG. 5, the first face 85 supports the friction material 90. The friction material 90 may be secured onto the first face 85 by any suitable means, such as a bonding adhesive or mechanical fastening (e.g. riveting, or integrally moulding the friction material on the backplate 80).

The backplate 80 has a generally trapezoidal shape, with first side 81, a second side 82, an outer side 83, and an inner side 84. As shown, the first side 81 is disposed opposite the second side 82. Similarly, the outer side 83 is disposed opposite the inner side 84. The backplate 80 has a vertical direction Y that extends from the inner side 84 to the outer side 83. The outer side 83 extends from the first side 81 towards the second side 82. The inner side 84 also extends from the first side 81 to the second side 82. When the backplate 80 is received within the cavity 70, the outer side 83 defines a radially outer edge of the backplate 80. The inner side 84 therefore defines a radially inner edge of the backplate 80. The vertical direction Y of the backplate 80 therefore extends from the radially outer edge 83 to the radially inner edge 84.

The backplate 80 is designed with specific dimensions to be used in heavy-duty vehicle disc brakes. The height H of the backplate 80 extends from the inner side 84 to the outer side 83, while the width W extends from the first side 81 to the second side 82. The height H of the backplate 80 may range from 100 mm to 115 mm. The width W of the backplate 80 may range from 205 mm to 215 mm. This range of dimensions allows the backplate 80 to be compatible with multiple disc brake assemblies. In the example illustrated in FIG. 3, the backplate 80 has a height of 105 mm and a width of 210 mm. However, it should be understood that any suitable height H or width W may be used for the backplate 80 in a disc brake assembly 10.

The backplate 80 may also include one or more horns 89. As illustrated in FIG. 3, the backplate 80 features two horns 89, which are substantially in the plane of the backplate 80 and extend radially outward from the outer side 83 of the backplate 80. In this example, the horns 89 are positioned at opposite sides of the outer side 83. The horns 89 are integrally formed with the backplate 80. As shown, the horns 89 extend from the backplate 80 to form receiving portions 89a. The receiving portions 89a of the horns 89 are concavely shaped and curve towards a central portion of the backplate 80. These receiving portions 89a are arranged to abut and cooperate with a pad spring such as a pad spring 150, as described in further detail below. While the backplate 80 shown in FIG. 3 has two horns 89, it will be understood that the backplate 80 may have any number of horns 89, and these horns 89 can be located at various positions along the width W of the backplate 80.

The backplate 80 also includes one or more protrusions 88. The backplate 80 shown in FIG. 3 has two protrusions 88 that extend radially outward from the outer side 83 of the backplate 80. In this example, the protrusions 88 are positioned on either side of the central axis Y of the backplate 80. Each protrusion is therefore positioned between the central axis of the backplate 80 and the horn 89. The protrusions 88 are integrally formed with the backplate 80. The protrusions 88 are arranged to position and receive the pad springs 150, 250, 350 (discussed in further detail below). While the backplate 80 shown in FIG. 3 has two protrusions 88, it will be understood that the backplate 80 may have any number of protrusions 88, and these protrusions 88 can be located at various positions along the width W of the backplate 80.

The backplate 80 also includes a slot 100 for receiving a sensor arrangement 28, shown more clearly in FIG. 5. FIG. 4A shows a front-view of the slot 100, while FIG. 4B shows a top-down view of the slot 100. In this example, the slot 100 has an open end 101 that is arranged on the outer side 83 of the backplate 80. The slot 100 is arranged substantially midway along the outer side 83 of the backplate 80. In this arrangement, the centre point of the slot 100 (defined along the central vertical axis Y from the outer side 83 of the backplate and indicated schematically by point 100b) is located halfway between the first side 81 and the second side 82. However, in other examples, the slot 100 may be arranged at any position along any outer edge 81, 82, 83, 84 of the backplate 80. Similarly, the open end 101 of the slot 100 may be arranged along any outer edge 81, 82, 83, 84 of the backplate 80. The slot 100 is relatively easy to manufacture because the open end 101 of the slot 100 is positioned along the y outer edge of the backplate 80. It is preferable to have the slot 100 formed on the radially outer edge 83 (i.e. the outer side 83 of the backplate 80) because the slot 100 is easily accessible once the backplate assembly 24 is installed in the cavity 70. The sensor 28 can therefore be easily mounted onto the backplate 80.

As shown more clearly in FIG. 4B, the slot 100 extends through the backplate 80 from the first face 85 to the second face 86. The slot 100 is therefore a through-hole that extends through the entire depth D of the backplate 80 in the axial direction X. The depth D of the backplate 80 may be 5 mm to 15 mm. The cross-sectional area of the slot 100 is arranged to receive the sensor assembly 28. The slot 100 has a varying cross-sectional area in the axial direction X from the first face 85 to the second face 86 of the backplate 80, as described in more detail in relation to FIG. 4B.

The slot 100 has a first region 110, a second region 120 and a third region 130. The first region 110 is proximal to the first face 85 of the backplate 80. The first region 110 has a first cross-sectional area 111. The first region 110 has a generally elongated U-shape and has a depth D1 that extends through the first region 110. The depth D1 may be 2 mm to 5 mm, or larger. The curved portion of the U-shape of the first region 110 may have a radius between 2 mm to 8 mm, or larger. The second region 120 is proximal to the second face 86 and has a second cross-sectional area 121. In this example, the second region 120 is formed as a recess 122 in the second face 86 of the backplate 80. As shown in FIG. 4A, the second region 120 is generally U-shaped and has a depth D2 that extends through the second region 120. The depth D2 may be 1 mm to 3 mm, or larger. The curved portion of the U-shape of the second region 120 may have a radius between 8 mm to 14 mm, or larger. The second cross-sectional area 121 of the second region 120 is larger than the first cross-sectional area 111 of the first region 110. The change in cross-sectional area between the first region 110 and the second region 120 allows the slot 100 to accommodate several sensor arrangements 28. Similarly, the depth D1 of the first region 110 is greater than the depth D2 of the second region 120. The change in cross-sectional area from the first region 110 to the second region 120 allows a sensor 28 to be located in the slot 100 without any additional fixtures or securing mechanisms. The slot 100 therefore provides an easy way to install a sensor 28 on to the brake pad assembly 24. The change in cross-sectional area between the regions 110, 120 also limits movement of the sensor in the axial direction X. This allows the sensor 28 to be held securely on the backplate 80.

The third region 130 is provided between the first region 110 and the second region 120 and has a third cross-sectional area 131. The third region 130 in this example is at least partially formed from a second recess 132. The second recess 132 from the first face 85 of the backplate 80 to the second face 86. In this example, the second recess 132 is formed in the first recess 122. The third region 130 is generally U-shaped and has a depth D3 that extends through the third region 130, between the first region 110 and the second region 120. The depth D3 may be 1.5 mm to 4 mm, or larger. The curved portion of the U-shape of the second region 120 may have a radius between 3 mm and 8 mm, or larger. The second region 120 has a cross-sectional area 121 that is greater than the cross-sectional area 131 of the third region 130. Similarly, the third cross-sectional area 131 of the third region 130 is greater than the first cross-sectional area 111 of the first region 110. The depth D1 of the first region 110 in the axial direction X is greater than a depth D3 of the third region 130 in the axial direction X. The change in cross-sectional area from the first region 110, third region 130 and to the second region 120 allows a sensor 28 to be located in the slot 100 without any additional fixtures or securing mechanisms.

The first, second and third region 110, 120, 130 of the slot 100 overlap to form a through-hole 100a that extends from the first face 85 to the second face 86 of the backplate 80. The cross-sectional area of the slot 100 decreases in an axial direction from the back face 86 to the front face 85. The change in cross-sectional area of the slot 100 changes from the first region 110 to the second region 120 in a stepped arrangement 125. The change in cross-sectional area is therefore not a gradual change and occurs in a sequential manner. In this example, the sidewalls that form the first region 110, second region 120 and third region 130 are substantially parallel with the axial direction X of the backplate 80. In other arrangements, the sidewalls that form the first region 110 and/or the second region 120 and/or third region 130 may be angled relative to the axial direction X. In such arrangements, the sidewalls may be angled from 1° to 20° or greater relative to the axial direction X. In this example, the cross-sectional area of the slot 100 changes between the first region 110, third region 130, and the second region 120 in a stepped arrangement 125. The cross-sectional area of the slot 100 therefore decreases from the first region 110 to the third region 130 region, and further decreases from the third region 130 to the second region 120. This stepped arrangement 125 ensures a controlled reduction in cross-sectional area of the slot 100. The slot 100 can therefore be easily manufactured within a high tolerance to ensure accurate placement of the sensor arrangement 28. This may be particularly advantageous where the location of the slot 100 and sensor 28 is important relative to other assemblies within the disc brake assembly. 10.

The slot 100 also includes a recess 101a that forms the open end 101 of the slot 100. The recess 101a extends from the radially outer edge of the backplate 80. In this example, the recess 101a extends from the outer side 83 of the backplate 80. The recess 101a has a width in the range of 10 mm to 30 mm. The recess 101 a has a base 102 that is perpendicular to the axial direction X of the backplate 80. The recess 101a and the base 102 extends through the first, second and third regions 110, 120, 130 of the slot 100 and provides a base support to receive the sensor 28. The recess 101a extends through a neck 103 to a belly portion 104. The neck 103 defines a narrowed region of the slot 100 and is narrower with a lesser cross-sectional area than the recess 101a. The neck 103 may have a width between 3 mm to 25 mm. In this example, the belly portion 104 is an elongate ovoid that is wider than the neck 103. The belly portion 104 may have a width in the range of 4 mm to 25 mm. The belly portion 104 does not extend through the entire height of the slot 100. The neck 103 is arranged to secure the sensor 28 within the slot 100. The recess 101a, the neck 103 and the belly portion 104 all form the through-hole 100a that extends through the first, second and third regions 110, 120, 130 of the slot 100.

As shown in FIG. 4A, each region 110, 120, 130 has substantially the same shape. As the backplate 80 is manufactured as a metal plate, this allows the slot 100 to be manufactured easily as the same tool may be used to form the second region 120 before being used to form the third region 130 and the first region 110. In this example, each region 110, 120, 130 is generally U-shaped. The U-shape of the regions 110, 120, 130 allows the regions 110, 120, 130 to be easily manufactured using conventional manufacturing techniques, such as stamping. The slot 100 can therefore be manufactured easily. Furthermore, forming the regions 110, 120, 130 as U-shapes minimizes the stress concentrations in the backplate 80 because of the substantially rounded end of the slot 100. In this example, the slot 100 is U-shaped to accommodate a variety of sensor arrangements 28. In other examples, the slot 100 may be any suitable shape, such as trapezoidal, triangular or oval. The slot 100 therefore has a symmetrical cross-section along the vertical direction Y of the slot 100.

While the slot 100 is shown to have three regions 110, 120, 130, it will be understood that the slot 100 may be provided with only two regions (e.g. the first region 110 and the second region 120, the first region 110 and the third region 130 or the second region 120 and the third region 130).

Advantageously, the slot 100 is suitable for receiving multiple different types of sensors, and suitably locating them with respect to the disc brake assembly 10. FIG. 5 illustrates the reverse view of the brake pad assembly 24, which includes the friction material 90 and an exemplary sensor arrangement 28. The sensor 28 may be any suitable type, such as a temperature sensor, wear sensor, or general ‘health’ sensor of the brake pad assembly 24. The sensor 28 may be connected to other components within the disc brake assembly 10 or may be used exclusively to monitor the brake pad assemblies 24. The sensor arrangement 28 is designed to be received within the slot 100. The sensor arrangement 28 is specifically shaped to fit within the slot 100. Due to the narrowing cross-sectional design of the slot 100, the sensor 28 can be easily inserted in the vertical (radial) direction and securely ‘snapped’ into position. Consequently, the slot 100 provides a self-contained mechanism that does not require additional components to secure the sensor 28 into the backplate 80. Furthermore, while only one slot 100 and one sensor 28 is shown in FIG. 5, it will be understood that the backplate 80 may have several sensors received within the slot 100, or several slots 100 to receive various sensors 28 and/or sensor arrangements.

The friction material 90 is disposed on the first face 85 of the backplate 80 and faces toward the brake rotor 40. The friction material 90 may contact the brake rotor 40 during vehicle braking. The friction material 90 may be made of any suitable material.

The friction material 90 has a generally trapezoidal shape that corresponds with the shape of the backplate 80. The friction material 90 has a first face 95 and an opposing second face 96. The first face 95 of the friction material 90 is supported on the first face 85 of the backplate 80. The friction material 90 has a first side 91, a second side 92, an outer edge 93, an inner edge 94. As shown, the first side 91 is disposed opposite the second side 92. Similarly, the outer edge 93 is disposed opposite the inner edge 94. The outer edge 93 extends from the first side 91 towards the second side 92. The inner edge 94 also extends from the first side 91 to the second side 92. When the brake pad assembly 24 is installed within the cavity, the outer edge 93 of the friction material 90 defines a radially outer edge of the friction material 90.

The friction material 90 includes a slot 200 that extends through the friction material 90 from the first face 95 to the second face 96. The slot 200 is therefore a through-hole. In this example, the slot 200 is positioned midway between the two sides 91 and 92 of the friction material so that the slot 200 aligns with the slot 100 in the backplate 80 when the friction material 90 is mounted onto the backplate 80. In other examples, the slot 200 may overlap with the slot 100 in the backplate 80 without being exactly aligned. The sensor arrangement 28 is therefore also supported by the friction material 90. In the example where the sensor arrangement 28 is a wear sensor, as the friction material 90 is worn, due to the placement of sensor arrangement 28, the sensor arrangement 28 will contact the rotor 40. The sensor arrangement 28 can therefore send a signal to indicate wear of the brake pad assembly 24. In this example, the slot 200 is generally U-shaped and is larger than the slot 100 in the backplate 80. In other examples, the slot 200 may be any suitable shape to accommodate the sensor arrangement 28. The slot 200 has a varying cross-sectional area from along the axial direction X. As shown more clearly in FIG. 4B, the slot 200 has a first opening 95a on the first face 95 and extends to a second opening 96a on the second face 96. The width of the second opening 96a is larger than the width of the first opening 95a. The slot 200 therefore gradually increases in width along the axial direction X of the friction material 90. The sidewalls of the slot 200 are therefore tapered along the axial direction so the slot 200 gradually increases in width along the depth of the friction material 90 from the first face 95 to the second face 96.

The surface area between the first face 95 of the friction material 90 and the first face 85 of the backplate 80 defines a contact area ratio between the backplate 80 and the friction material 90. As the friction material 90 has a similar shape and size to the backplate 80, the contact ratio between the first face 95 of the friction material 90 and the first face 85 of the backplate 80 is increased. In this arrangement, the contact area ratio between the friction material 90 and the backplate 80 is within the range of 1.1 to 1.3. This increased contact area ratio between the friction material 90 and the backplate 80 enhances stability and performance by distributing braking force more evenly, reducing localized wear, and extending the lifespan of brake components. Furthermore, the large contact ratio significantly enhances heat dissipation. The larger surface area allows for more efficient heat transfer away from the friction material 90, maintaining optimal operating temperatures and preventing brake fade. It is also worth noting that the contact area ratio between the friction material 90 and the backplate 80 may be greater than 1.1 even without the presence of slots 100 and 200, indicating that the design alone can achieve the desired contact area ratio.

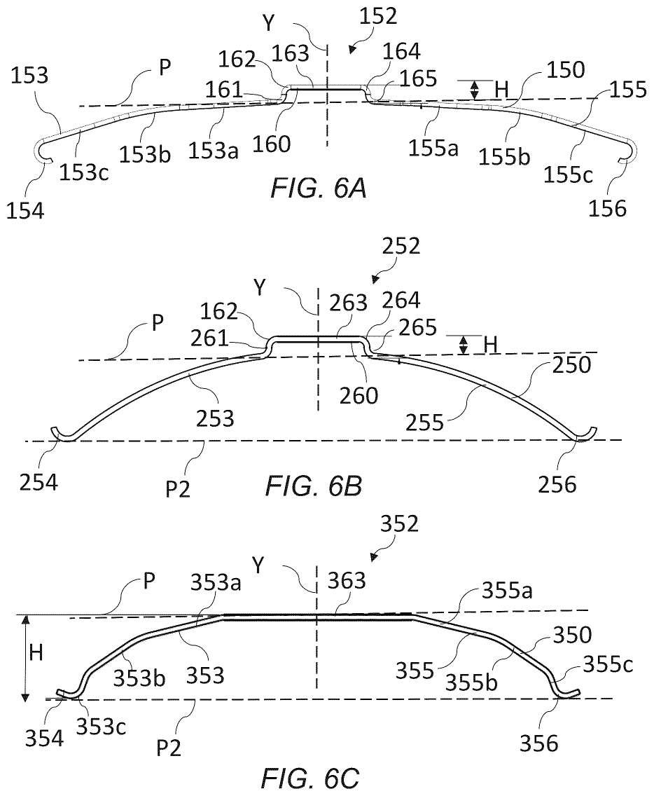

A pad spring 150 may be provided on the brake assembly 24 and may be at least partially disposed in the cavity 70. The pad spring 150 may exert a biasing force against a component that is received in the cavity 70 such as a brake pad assembly 24 or the tappet 60. In the configuration shown, three pad springs 150 are illustrated; however, it is contemplated that a lesser number of pad springs 150 may be provided. The pad springs 150 may be spaced apart from each other and may extend from the retainer strap 26 into the cavity 70. A first exemplary pad spring 150 is shown in FIG. 6A.

The pad spring 150 is arranged to be received on the radially outer edge 83 of the backplate 80 when the brake pad assembly 24 is installed in the cavity 70. Preferably the pad spring 150 is arranged on the same outer edge as the horns 89. In this example, the pad spring 150 is arranged to be received on the outer edge 83 of the backplate 80. The pad spring 150 is provided as an elongate piece of material, preferably a metal alloy, such as a steel alloy. The spring 150 is therefore less likely to reach failure during use in the disc braking system 10. The pad spring 150 is formed as one continuous component and is formed into the shape shown in FIG. 6A by any suitable means. The spring 150 is therefore easy to manufacture for the brake pad arrangement 24.

The spring 150 has a central longitudinal axis Y that is aligned with the vertical axis Y on the brake pad assembly 24. As shown, the pad spring 150 has a central portion 152 that is connected to a first end portion 154 through a first connector portion 153, and to a second end portion 156 through a second connector portion 155. The connector portions 153, 155 extend away from the central portion 152 in opposite directions. As shown in FIG. 6A, the connector portions 153, 155 define a plane P through which the elongate members 153, 155 extend. The connector portions 153, 155 are mirror images of each other, and so only connector portion 153 will be discussed in greater detail. However, it will be understood that the connector portion 155 is formed in a substantially identical manner.

The connector portion 153 has a first region 153a, a second region 153b, and a third region 153c. As shown, the first region 153a is a generally planar region that extends from the central portion 152 along plane P. The second region 153b is connected between the first and third regions 153a, 153c and has a bend radius with respect to the central axis Y of the spring 150. The connector 153 therefore bends away from the plane P through the second region 153b. Finally, the third region 153c is substantially planar and connects the second region 153b to the end portion 154. The bend radius of the second region 153 b may be anywhere between 5 mm to 25 mm depending on the backplate 80 dimensions.

As shown more clearly in FIG. 1, the second region 153b of the spring 150 forms a wider region of the spring 150 that accommodates a hole 151 that extends through the thickness of the spring 150. As shown, the hole 151 of the pad spring 150 is arranged to receive the protrusion 88 on the backplate 80. The pad spring 150 can therefore be accurately positioned in the pad brake assembly 24 by aligning the hole 151 of the pad spring 150 with the protrusion 88 on the backplate 80. Furthermore, the bend radius of the second region 153b is also used to accurately position the pad spring 150 to follow the curvature of the brake caliper in the pad brake assembly 24.

The end portions 154, 156 are arranged to co-operate with the horns 89 on the backplate 80. In the example shown in FIG. 6A, the first end portion 154 has a concave shape and curves inwardly towards the central longitudinal axis Y of the spring 150 (i.e. towards the central portion 152). Similarly, the second end 156 has a concave shape and curves inwardly towards the central longitudinal axis Y of the spring 150 (i.e. towards the central portion 152). The end portions 154, 156 curve inwardly with respect to the central axis Y of the spring in a range of 120° to 180°. Once the pad spring 150 is arranged in the brake pad assembly 24 (i.e. on the backplate 80), the first and second end 154, 156 curve inwardly towards the backplate 80. The outer surface of each end portion 154, 156 is arranged to be received within the receiving portion 89a of the horns 89 on the backplate 80. The spring 150 is therefore retained on the backplate 80 as the end portions 154, 156 are held in position under the horns 89, which limit axial movement of the end portions 154, 156. However, the end portions 154, 156 of the spring 150 are not rigidly fixed in the receiving portions 89a of the horns 89. This allows the spring 150 to have some axial movement, thereby allowing the spring 150 to compress and deform as required once assembled on the backplate 80.

The central portion 152 of the spring 150 has a protrusion 160 that extends radially outward in the vertical direction Y away from the plane P. The shape of the protrusion 160 is defined in relation to the central longitudinal axis Y. The protrusion 160 is formed by a first convex portion 161 connected to a first concave portion 162 that extends to a planar portion 163, and a second concave portion 165 connected to a second convex portion 165. The radius of the first concave portion 161 relative to the first connector portion 153 and the second concave portion 165 relative to the second connector portion 155 may be substantially 1.5 mm. Similarly, the radius of the first convex portion 162 relative to the planar portion 163 and the radius of the second convex portion 164 relative to the planar portion 163 may be substantially 1.5 mm. This minimizes the stress concentrations present in the spring 150 during use and minimizes the likelihood of the spring 150 breaking. This arrangement allows the protrusion 160 to be formed as one continuous component that is part of the spring 150. As shown, the protrusion 160 extends radially away from the plane P to define a height H between the planar portion 163 and the plane P. In this example, the height H of the protrusion 160 is in the range of 2 mm to 10 mm relative to the connector portions 153, 155. In other examples, the height H of the central portion 154 may be in the range of 4 mm to 8 mm. The spring 150 can therefore be used with the backplate 80 described above as the central portion 152 of the spring 150 allows the sensor 28 to be received in the slot 100 underneath the protrusion 160.

FIG. 6B shows another pad spring 250 to be used with the brake pad assembly 24. Corresponding features of the pad spring 250 shown in FIG. 6B to the pad spring 150 shown in FIG. 6A will be denoted with reference numerals +100. Identical features of the pad spring 250 will not be repeated for brevity.

The pad spring 250 has a central portion 252 that is connected to a first end portion 254 through a first connector portion 253, and to a second end portion 256 through a second connector portion 255. The connector portions 253, 255 are substantially curved parts of the spring 250 that extend away from the central portion 252 in opposite directions. As shown in FIG. 6B, the connector portions 253, 255 have a curvature with a radius with respect to the vertical longitudinal axis Y of the pad spring 250. In some examples, the radius of the connector portions 253, 255 may be 5 mm to 15 mm. The bend radius of the connector portions 253, 255 is constant. Although not shown in FIG. 6B, the spring 250 includes holes along the connector portions 253, 255 (similar to the holes 151 in pad spring 150) that are arranged to engage with the protrusions 88 on the backplate 80. The overall height of the spring 250 (taken from the plane P2 of the end portions 254, 256 to the planar portion 263 of the protrusion 260) allows the spring 250 to be easily seated on the backplate 80 without interfering with the sensor arrangement 28. The overall height of the spring 250 may be in the range of 10 mm to 30 mm.

The end portions 254, 256 are arranged to co-operate with the outer side 83 of the backplate 80. The end portions 254, 256 are arranged to be positioned between the protrusions 88 and the horns 89 and are retained on the backplate 80 by engaging the holes on the spring 250 with the protrusions 88. In the example shown in FIG. 6B, the first end portion 154 has a concave shape and curves outwardly away from the central longitudinal axis Y of the spring 250 (i.e. away from the central portion 252). Similarly, the second end 256 has a concave shape and curves outwardly away from the central longitudinal axis Y of the spring 250 (i.e. away from the central portion 252). The end portions 254, 256 curve outwardly away from the central axis Y of the spring 250 in a range of 80° to 180°. Once the pad spring 250 is arranged in the brake pad assembly 24 (i.e. on the backplate 80), the first and second end 254, 256 curve outwardly away from the backplate 80.

FIG. 6C shows alternative pad spring 350 to be used with the brake pad assembly 24. Corresponding features of the pad spring 350 shown in FIG. 6C to the pad spring 250 shown in FIG. 6B will be denoted with reference numerals +100. Identical features of the pad spring 350 will not be repeated for brevity.

The pad spring 350 has a central portion 352 that is connected to a first end portion 354 through a first connector portion 353, and to a second end portion 356 through a second connector portion 355. The connector portions 353, 355 are substantially curved parts of the spring 350 that extend away from the central portion 352 in opposite directions. As shown in FIG. 6C, the connector portions 353, 355 each include a first connector region 353a, 355a, a second connector region 353b, 355b and a third connector region 353c, 355c. While the overall shape of the connector portions 353. 355 are curved with respect to the longitudinal axis Y of the pad spring 350, the third connector portions 353c, 355c are inclined with respect to the second connector portions 353b, 355b. Similarly, the second connector portions 353b, 355b are inclined with respect to the first connector portions 353a, 355a along the axis Y. Finally, the first connector portions 353a, 355a which are adjacent the central portion 352, are inclined relative to the central portion 352. The angle between the first connector portions 353a, 355a and the second connector portions 353 b, 355 b may be between 5° and 25°, or greater. The angle between the second connector portions 353 b, 355 b and the third connector portions 353 c, 355 c may be between 40° and 70°, or greater. The connector portions 353a, 353b, 353c are generally planar. In the example shown, the connector portions 353, 355 have three connector regions, but it will be understood that the connector portions 353, 355 may have any number of regions. In other examples, the connector portions 353, 355 may have a smooth, continuous radius (as with the spring 250 shown in FIG. 6B). The overall height of the spring 350 (taken from the plane P2 of the end portions 354, 356 to the planar portion 363 of the central portion 352) allows the spring 350 to be easily seated on the backplate 80 without interfering with the sensor arrangement 28. The overall height of the spring 350 may be between 15 mm to 30 mm, or greater.

Although not shown in FIG. 6C, the spring 350 includes holes along the connector portions 353, 355 (similar to the holes 151 in pad spring 150) that are arranged to engage with the protrusions 88 on the backplate 80. The end portions 354, 356 are arranged to co-operate with the outer surface 83 of the backplate 80. The end portions 354, 356 are arranged to be positioned between the protrusions 88 and the horns 89 and are retained on the backplate 80 by engaging the holes on the spring 350 with the protrusions 88. In the example shown in FIG. 6C, the first end portion 254 has a concave shape and curves outwardly away from the central longitudinal axis Y of the spring 350 (i.e. away from the central portion 352). Similarly, the second end 356 has a concave shape and curves outwardly away from the central longitudinal axis Y of the spring 350 (i.e. away from the central portion 352). Each end portion 354, 356 is arranged to be received within the receiving portion 89a of the horns 89 on the backplate 80. The end portions 254, 256 curve outwardly away from the central axis Y of the spring 250 in in a range of 20° to 180°. Once the pad spring 350 is arranged in the brake pad assembly 24 (i.e. on the backplate 80), the first and second end 354, 356 curve outwardly away from the backplate 80.

The configuration of the pad springs 150, 250, 350 allow the springs to be used in multiple different brake pad assembly 24 designs, and function with several caliper designs. This is because due to the geometry of the pad springs 150, 250, 350, the pad springs can be loaded at several points along the length of the springs. In some examples, the springs 150, 250, 350 may be loaded at one load point, preferably along the central axis Y of each spring 150, 250, 350, i.e. on the central portion 152, 252, 352. This allows the springs 150, 250, 350 to deform uniformly and deflect axially towards the backplate 80. In other examples, the springs 150, 250, 350 may have at least two loading points on each connector portion 153, 155, 253, 255, 353, 355. In other examples still, the springs 150, 250, 350 may be loaded at several locations along the length of the spring. Each spring 150, 250, 350 can accommodate such varied loading arrangements in several different brake pad assemblies due to their height and geometry. This arrangement allows the springs 150, 250, 350 to operate in brake pad assemblies 24 of different sizes and configurations.

Although the disclosure has been described above with reference to one or more preferred examples, it will be appreciated that various changes or modifications may be made without departing from the scope of the appended claims.

What is claimed is:

1. A brake pad assembly for a heavy-duty vehicle disc brake, the brake pad assembly comprising:
a backplate; and
friction material supported on the backplate, wherein the backplate comprises:
a first face for supporting the friction material;
a second face, opposing the first face; and
a slot for receiving a sensor arrangement, the slot extending through the backplate from the first face to the second face;
wherein the slot has a varying cross-sectional area through the backplate.

2. The brake pad assembly of claim 1, wherein the slot includes:
a first region proximal to the first face, the first region having a first cross-sectional area,
a second region proximal to the second face, the second region having a second cross-sectional area,
wherein the second cross-sectional area is greater than the first cross-sectional area.

3. A brake pad assembly of claim 2, wherein the backplate defines an axial direction extending from the first face to the second face, and wherein the change in cross-sectional area from the first region to the second region allows a sensor to be located in the slot to limit movement of the sensor in the axial direction.

4. The brake pad assembly of claim 3, wherein the slot further includes:
a third region between the first region and the second region, the third region having a third cross-sectional area,
wherein the second cross-sectional area of the second region is greater than the third cross-sectional area of the third region.

5. The brake pad assembly of claim 4, wherein the first cross-sectional area is less than the third cross-sectional area.

6. The brake pad assembly of claim 4, wherein the backplate defines an axial direction extending from the first face to the second face, and a depth of the first region in the axial direction is greater than a depth of the third region in the axial direction.

7. The brake pad assembly of claim 1, wherein the backplate defines a vertical direction extending from a radially outer edge to a radially inner edge of the backplate, wherein the slot has a symmetrical cross-section along the vertical direction of the slot.

8. The brake pad assembly of claim 4, wherein each region has substantially the same shape.

9. The brake pad assembly of claim 1, wherein the slot includes a recess that extends from a radially outer edge of the backplate, the recess having a base that is substantially perpendicular to an axial direction through the backplate.

10. A brake pad assembly of claim 9, wherein the slot further includes a neck connecting the recess to a central portion of the slot, wherein the neck is configured to secure a sensor within the slot.

11. The brake pad assembly of claim 1, wherein the friction material defines a slot extending through the friction material, and the slot has a varying cross-sectional area through the friction material.

12. A brake pad assembly for a heavy-duty vehicle disc brake, the brake pad assembly comprising:
a backplate; and
friction material supported on the backplate, wherein the backplate comprises:
a first face for supporting the friction material;
a second face, opposing the first face;
wherein a contact area ratio between the first face and the friction material is greater than 1.1.

13. A brake pad assembly for a heavy-duty vehicle disc brake, the brake pad assembly comprising:
a backplate;
friction material supported on the backplate;
wherein the backplate comprises:
a first face for supporting the friction material;
a second face, opposing the first face;
at least two horns extending from a radially outer edge of the backplate; and
a pad spring received on a radially outer edge of the backplate;
wherein the pad spring comprises:
a central portion comprising a protrusion extending in a radially outward direction away from the backplate;
first and second end portions for co-operation with respective horns on the backplate; and
connector portions between the central portion and respective end portions;
wherein the protrusion has a height in a range of 2 mm to 10 mm relative to the connector portions.

14. The brake pad assembly of claim 13, wherein the end portions of the pad spring are curved inwardly towards the backplate.

15. The brake pad assembly of claim 13, wherein the end portions are curved outwardly away from the backplate.

16. The brake pad assembly of claim 13, wherein the connector portions are substantially arcuate.

17. The brake pad assembly of claim 13, wherein the central portion includes a protrusion extending in a radially outward direction away from the backplate.

18. The brake pad assembly of claim 17, wherein the protrusion has a height in a range of 2 mm to 10 mm relative to the connector portions.

19. The brake pad assembly of claim 13, wherein the central portion is substantially planar with respect to a central axis of the pad spring.

20. The brake pad assembly of claim 13, wherein each connector portion has a first connector region and a second connector region, wherein the second connector region is inclined with respect to the first connector region along the central axis.
